(19) United States
(12) Patent Application Publication
(10) Pub. No.: US 2019/0391519 A1
(43) Pub. Date: Dec. 26, 2019

(54) SIGNAL PROCESSING IN A LIQUID ELECTROPHOTOGRAPHIC PRINTER

(71) Applicant: HP Indigo B.V., Amstelveen (NL)

(72) Inventors: Tsafrir Yedid Am, Ness Ziona (IL); Moshe Haim, Ness Ziona (IL); Rivay Mor, Ness Ziona (IL)

(73) Assignee: HP Indigo B.V., Amstelveen (NL)

(21) Appl. No.: 16/465,314

(22) PCT Filed: Feb. 10, 2017
(86) PCT No.: PCT/EP2017/053080

§ 371 Date: May 30, 2019

(51) Int. Cl. G03G 15/00; G03G 15/10

(52) U.S. Cl. CPC G03G 15/5037; G03G 15/10

(57) ABSTRACT

In an example, a method of operating a liquid electrophotographic printer is described. The method involves applying limits to a printer control signal. In particular, the printer control signal is digitally processed to reduce signal values to within the obtained limits, wherein neighboring values are modified to maintain the total energy of the printer control signal. The liquid electrophotographic printer is controlled using the processed printer control signal.

### BACKGROUND

Liquid Electro-Photographic (LEP) printing devices form images on print media by placing a uniform electrostatic charge on a photoreceptor and then selectively discharging the photoreceptor in correspondence with the images. The selective discharging forms a latent electrostatic image on the photoreceptor. Ink comprising charged colorant particles suspended in imaging oil is then developed from a developer unit on to the latent image formed on the photoreceptor. The image developed on the photoreceptor is offset to an image transfer element, where it is heated until the solvent evaporates and the resinous colorants melt. This image layer is then transferred to the surface of the print media.

### BRIEF DESCRIPTION OF THE DRAWINGS

Various features of the present disclosure will be apparent from the detailed description which follows, taken in conjunction with the accompanying drawings, which together illustrate features of the present disclosure, and wherein:

FIGS. 1A and 1B are flowcharts showing a method of operating a liquid electrophotographic printer according to an example.

FIG. 2A is a schematic illustration showing components of a liquid electrophotographic printer according to an example.

FIG. 2B is a schematic illustration showing a voltage controller and aspects of a binary ink developer unit according to an example.

FIG. 3A is a chart showing a printer control signal according to an example, FIG. 3B is a chart showing derivative values of the printer control signal and FIG. 3C is a chart showing a comparative printer control signal.

FIG. 4 is a schematic illustration showing instructions stored within an example non-transitory machine-readable storage medium.

### DETAILED DESCRIPTION

In LEP printing devices it is desired to have accurate, uniform and consistent print outputs. In certain cases, if a printer control signal is too high or too low, or changes too rapidly, this may lead to inaccurate, non-uniform or inconsistent print outputs, e.g. undesirable print artifacts may be visible in the print outputs. To reduce print artifacts in print outputs, a printer control signal may be compensated. For example, to produce accurate, uniform and consistent print outputs, signal values may be restricted within defined bounds. These bounds may comprise a minimum and/or maximum value of the signal. These bounds may be applied to the magnitude of a signal where negative values are present, e.g. signal values are limited to a range between −x₁ and +x₂. In certain cases, the bounds may be applied to differentiated signals. However, limiting signal values to within a set of bounds may introduce other signal discontinuities and/or signal artifacts that affect print quality. As such, it may be difficult to compensate printer control signals to allow accurate, uniform and consistent print outputs without affecting print output.

Certain examples described herein maintain print quality while limiting printer control signals. This is achieved by conserving the energy of a printer control signal following the application of limits to the signal. This enables accurate, uniform and consistent print outputs to be produced. The energy of the signal may be conserved by modifying neighboring signal values. For example, units of value may be redistributed to other samples of the signal while maintaining the constraint that the energy of the signal is not changed. The energy of the signal may be defined as the sum of the squared magnitudes of the sample values.

In one case, the signal may comprise a developer voltage signal, i.e. a signal to control a voltage level of a developer unit within the LEP printing device. The developer unit may comprise a binary ink developer (BID) unit. A developer unit supplies ink comprising charged colorant particles suspended in imaging oil to a selectively charged photo-imaging plate (PIP). This enables an inked image made up of a film of said ink to be formed on the PIP for transfer to a media substrate. The higher the voltage applied to the developer unit, the greater the voltage difference between the developer unit and the PIP, and the more ink is transferred to the PIP. The inked image may comprise one color separation that is transferred to an intermediate cylinder before transfer to the media substrate. The media substrate may comprise paper, polymers or other materials. In one case, the LEP printing device comprises a plurality of developer units, wherein each unit enables a different color separation to be formed on the intermediate cylinder. In certain cases, the color separations, in the form of thin films of ink, are layered upon the intermediate cylinder before transfer to the media substrate; in other cases, each color separation is applied in a separate pass of the media substrate. By processing a developer voltage signal as described herein, artifacts in print output may be reduced or avoided. For example, processing of a developer voltage signal in the manner described herein enables a smooth transition between image areas of higher and lower optical density.

In another case, a printer control signal may indicate a desired position of a mechanical component within an LEP printer. Processing such a printer control signal as described in examples herein enables a smooth movement of the mechanical component while ensuring that movements to instructed positions are completed. Smooth movements of mechanical components can reduce mechanical wear and prolong component life.

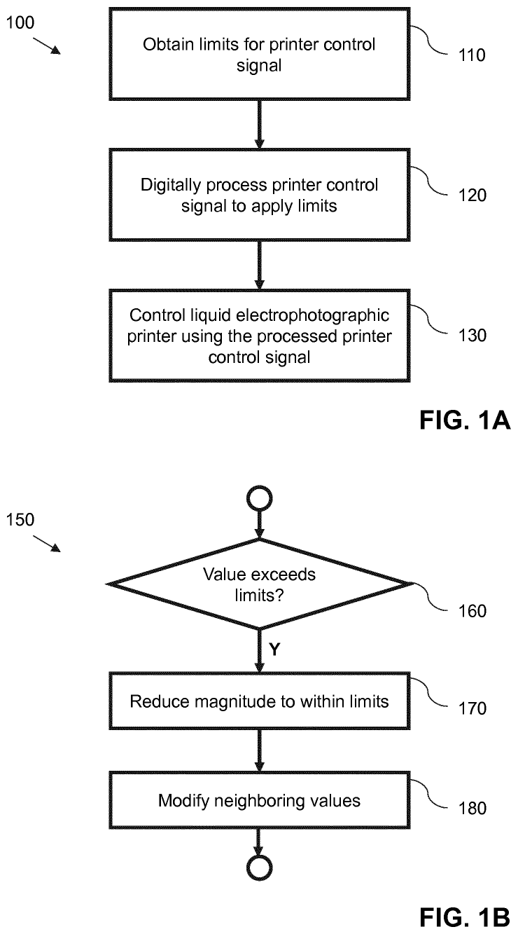

FIGS. 1A and 1B show aspects 100, 150 of an example method for operating a LEP printer.

In the method 100 of FIG. 1A, at block 110, a set of limits for a printer control signal is obtained. At block 120, the printer control signal is digitally processed to apply the obtained limits. This digital processing includes the blocks shown in FIG. 1B and described below. The digital processing outputs a processed printer control signal. At block 130, the LEP printer is controlled using the processed printer control signal.

The method 150 of FIG. 1B shows the blocks that are performed as part of block 120 in FIG. 1A. The method 150 is repeated for a set of values of the printer control signal. At block 160, a check is made to determine whether a current value of the printer control signal exceeds one of the obtained limits. The term “exceed” as used herein may correspond to a signal value having a value greater than one of the obtained limits or having a value equal to or greater than one of the obtained limits, depending on the implementation. If the signal has a range of both negative and positive values, the term “exceed” may correspond to a magnitude of a negative value exceeding a magnitude of a negative limit, e.g. if the limits comprise −5 and +5, then a value of −6 would exceed the negative limit of −5. In certain cases, the limits may be applied to a pre-processed version of the printer control signal. At block 170, responsive to the current value of the printer control signal exceeding one of the obtained limits, the magnitude of the value is reduced such that it lies within the obtained limits. This may comprise reducing the magnitude of the value to below one of the obtained limits, or to one of the obtained limits, depending on the implementation. For a negative value, this may comprise increasing the value, e.g. to −4 from −6 if a limit is −5. At block 180, neighboring values are modified to maintain the total energy of the printer control signal. This may comprise adding units of magnitude that are subtracted from the current value to one or more surrounding values. The method of FIG. 1B may then be repeated for other values of the printer control signal, where blocks 170 and 180 are applied when a value of the printer control signal exceeds one of the obtained limits.

The printer control signal may comprise a discrete signal comprising a set of signal samples. Each sample may have a sample value. The discrete signal may be represented as a vector or an array of sample values, e.g. [−5, −3, 1, 0, 4, 5, 2, −3]. Each sample may correspond to a discrete sample point, e.g. a point in time or an increment in a printer process. A discrete sample point may correspond to an index in a vector or array of sample values, e.g. index 0 may correspond to a first time value t=0 or a first increment in a printer process. As such the printer control signal may comprise a discrete digital signal. Signal values may comprise integer or float values. Neighboring values may comprise one or more other sample values in the vector or array of sample values.

Obtaining limits for the printer control signal at block 110 may comprise retrieving one or more limit or bound values from an accessible memory, such as writable or read-only flash memory. This may comprise a memory within control electronics for the LEP printer. One limit may be applied to both positive and negative values, e.g. a value of 10 may represent a limit of −10 or +10. In other cases, positive and negative limits may be supplied. In further cases, one of a positive and negative limit may be supplied, e.g. if the signal comprises positive values. In certain cases, the limits may represent electrical or mechanical operational bounds for the signal, e.g. values above and/or below the limits may risk electrical or mechanical failure within the LEP printer.

In one case, neighboring values may be identified using an energy spread function. The energy spread function is configured to identify surrounding signal samples to receive redistributed units of value from a signal sample with a value exceeding one of the obtained limits. The energy spread function may comprise a windowing function. The windowing function may have parameters that identify a window of length n samples before and/or after a current sample value. The windowing function may be symmetrical (e.g. have a width of n samples both before and after a current sample value) or asymmetrical (e.g. have a width of n₁ samples before a current sample value and n₂ samples after the current sample value, wherein n₁ or n₂ may be zero). If the sample is at or near the start or end of the printer control signal, then the window may be truncated so as not to extend beyond the extent of the printer control signal.

In one case, block 170 may comprise reducing the magnitude of a signal value by a discrete quantity, e.g. by x units. If the signal comprises integer signal values, x may comprise one unit of magnitude. Blocks 160 to 180 may be performed iteratively until a current value has a magnitude that is below one of the obtained limits. For example: the magnitude of a value may be reduced by x units; one sample within a given number of samples may be selected; the magnitude of the latter sample may be increased by x units; and then the reduced value may be checked to determine if it is now within the obtained limits. If it is not within the obtained limits, the process may be repeated. In each repetition, a different sample within a given number of samples may be selected, e.g. according to a defined energy spread function. In certain cases, a given neighboring sample may be selected multiple times, e.g. receive two or more sets of x units. Units are added under the constraint that the new value of the neighboring sample should not exceed the obtained limits. If adding units of magnitude would result in a new value that exceeded the obtained limits, then another neighboring sample may be selected in an iterative manner. The energy spread function may, in certain cases, attempt to distribute units of magnitude according to a Gaussian or normal distribution, i.e. more energy is redistributed to closer samples.

In certain cases, digitally processing the printer control signal may comprise obtaining a derivative of the printer control signal; and comparing values of the derivative of the printer control signal with the obtained limits. Obtaining a derivative may comprise computing the derivative as a form of pre-processing. In this case, the magnitude of a value of the derivative of the printer control signal may be reduced if the value of the derivative of the printer control signal exceeds one of the obtained limits. Correspondingly, neighboring values of the derivative of the printer control signal may be increased in magnitude, so as to retain a common sum of derivative sample values. In this case, the modified values of the derivative of the printer control signal may be integrated to generate the processed printer control signal. In certain cases, higher order derivatives may also be computed and limited.

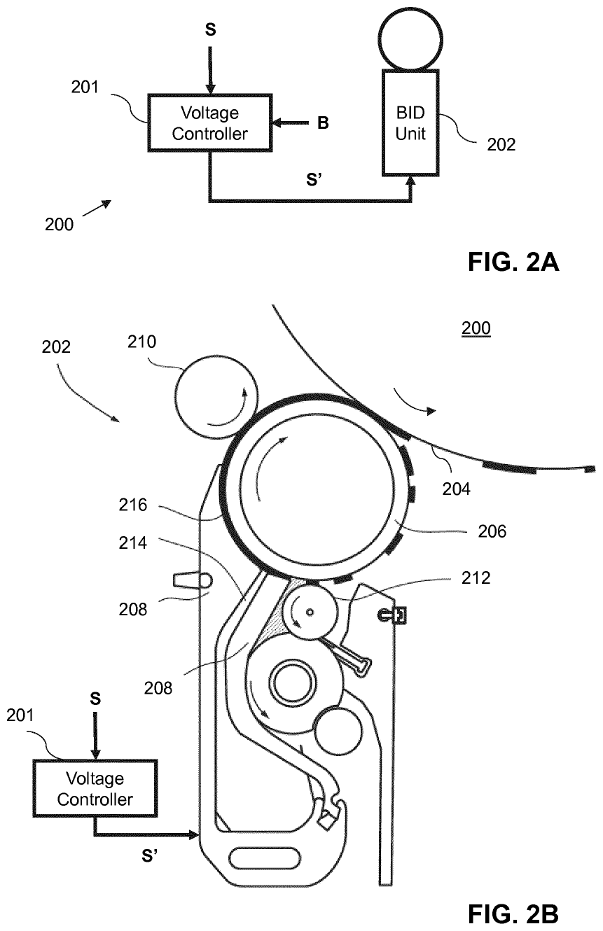

An example of processing a printer control signal in an LEP printer will now be described with reference to the printer components of FIG. 2A. FIG. 2A illustrates two example components of a LEP printer 200. These components may comprise part of a print engine for the LEP printer. The LEP printer 200 includes a voltage controller 201 and a BID unit 202 to develop an ink image on a PIP. The BID unit 202 has a development function that develops the ink onto the photoreceptor. The BID unit 202 may have several internal rollers and surfaces that are each differentially electrified with voltages. The voltage controller 201 may comprise a processor, such as a microprocessor, central processing unit, or digital signal processor, adapted to process digital signals. The voltage controller 201 may comprise writable memory to store signal values and the results of processing.

In FIG. 2A, the voltage controller 201 is configured to receive a signal S for the BID unit 202. The voltage controller 201 is configured to clip the signal S within predefined bounds B. This may comprise reducing the magnitude of signal values as described above. The voltage controller 201 is configured to then process the signal to maintain the energy of the originally received signal S. This results in a processed signal S′. As shown in FIG. 2A, the voltage controller 201 supplies the processed signal S′ to the BID unit 202 for use in setting voltage values during a print operation. Digital sample values within the processed signal S′ may be used by microcontrollers within the BID unit, or by control processors of the print engine that set voltages of the BID unit.

FIG. 2B shows the voltage controller 201, together with further details of an example BID unit 202 that may be used in certain implementations. In the example of FIG. 2B, the BID unit 202 includes a developer cylinder 206 and an electrode 208. In certain implementations, the BID unit 202 has a cleaning function that removes residual ink from the developer roller 206 and also includes a squeegee roller 210 and a cleaning cylinder 212. Although one BID unit 202 is shown in FIG. 2B, the LEP printer 200 may comprise more than one BID unit 202 and the components of the BID unit 202 may vary between implementations. In some examples, the LEP printer 202 may comprise multiple BID units 202 each to transfer a different color ink. For example, a print engine may comprise seven BID units 202. In the case of FIG. 2B, an increment in the printing process may comprise an incremental rotation of the developer cylinder 206 or incremental movement of PIP 204.

During a printing operation, the surface of the PIP 204 may be selectively charged to include charged and discharged areas that define a latent electrostatic image. Differential potentials are applied to at least the developer cylinder 206 and the one or more electrodes 208 to charge ink particles and create an electric field between the BID unit 202 and the PIP 204. In certain cases, differential potentials may also be applied to the squeegee roller 210 and the cleaning cylinder 212.

The developer cylinder 206 may be charged to a voltage which is intermediate the voltage of the charged and discharged areas on the PIP 204. Liquid toner comprising ink particles suspended in an imaging oil, flows through an ink channel 214 to a space between the charged developer cylinder 206 and charged electrode 208. The electrode 208 may be charged to a voltage higher than the voltage to which the developer cylinder 206 is charged. For example, the electrodes may be at a potential of −1200V and the developer cylinder may be at a potential of −400V. The potential difference between the electrode 208 and the developer cylinder 206 may charge the ink particles and cause the charged ink particles to flow to the developer cylinder 206.

Ink particles are deposited on the developer cylinder 206 as a layer of ink particles 216. The squeegee roller 210 may be configured to apply pressure on the developer cylinder 206 to squeeze excess imaging oil out of the layer of ink particles 216 on the surface of developer cylinder 206, further concentrating the ink layer 216. In some examples, the squeegee roller 210 may be charged to a voltage to repel the charged ink particles deposited on the developer cylinder 206. For example, the squeegee may be at a potential of −700V.

The developer cylinder 206 bearing the layer of ink particles 216 engages the PIP 204. The difference in potential between the developer cylinder 206 and the PIP 204 causes selective transfer of the layer of ink particles 216 to the PIP 204 to develop onto the latent electrostatic image, forming an ink image. Depending on the choice of ink charge polarity and the use of a “write-white” or “write-black” system, the layer of ink particles 216 will be selectively attracted to either the charged or discharged areas of the PIP 204, and the remaining portions of the ink layer 216 will continue to adhere to the developer cylinder 206. The larger the difference in potential between the developer cylinder 206 and the PIP 204, the more ink is transferred to the PIP and the greater the optical density of the inked image.

In certain cases, the cleaning cylinder 212 may be charged with a voltage potential to strip the remaining portions of the ink layer 216 from the developer cylinder 206 and wrap those remaining portions on the cleaning cylinder 212. For example, the cleaning cylinder 212 may be at a potential of −200V.

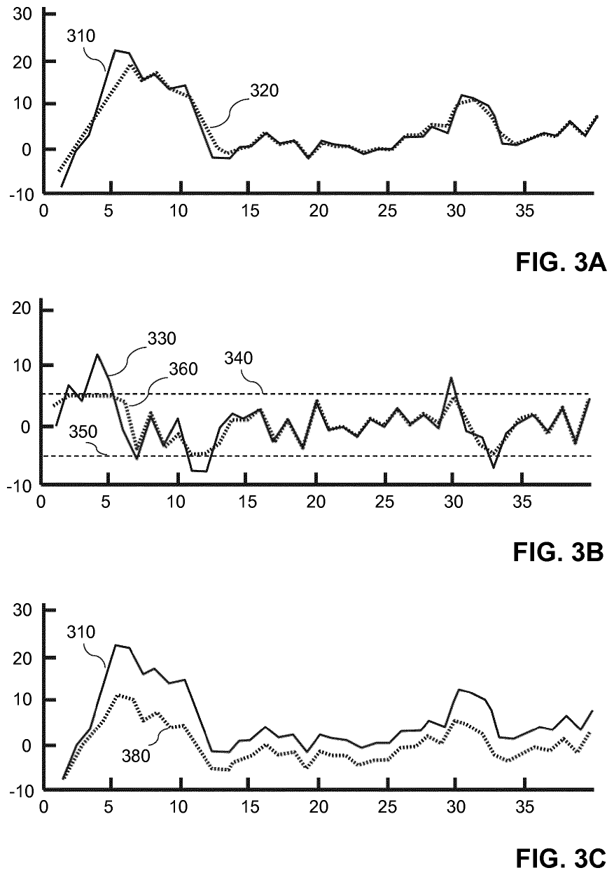

FIG. 3A is a chart showing a printer control signal 310 that may be used to control a developer unit, such as BID unit 202, according to an example. The y-axis indicates a change in developer voltage (in Volts) and the x-axis indicates units of change in the process direction, i.e. discrete samples are plotted along the x-axis where each sample or x-value corresponds to a different position on the PIP as it rotates, corresponding in turn to different portions of an inked image. The signal 310 may be seen as an example of S in FIG. 2A. The changes in developer voltage may be applied to apply solid uniformity correction, wherein higher and lower developer voltages result in darker and lighter solid blocks of image, which have corresponding higher and lower optical density. Hence, the changes in developer voltage may be computed based on the image to be printed to attempt to ensure uniform solid areas of color in a printed image. In this sense, the signal 310 corresponds to a correction that is applied at the developer unit.

From an analysis of print output, limits for the printer control signal 310 may be determined. For example, it may be determined that sharp changes in developer voltage (i.e. high positive and/or negative rates of change) result in artifacts that are visible in a print output. These artifacts affect print quality. Print output may be analyzed visually, e.g. as part of a quality control process, and/or using opto-electrical methods. In one case, the printer control signals that are used to produce print output with detectable artifacts may be obtained, e.g. from print control systems and analyzed.

In certain cases, limits for the printer control signal 310 may be applied to the derivative of the signal. For example, to reduce sharp changes in developer voltage, limits may be applied to the derivative of the signal 310. The derivative of the signal may be computed following receipt of the signal values, e.g. using automatic or numerical differentiation functions.

FIG. 3B shows the derivative 330 of the printer control signal 310 of FIG. 3A. In this case, e.g. from analysis of the print output, it is determined that changes of magnitude of more than 5 volts per x-axis increment results in non-uniformities in blocks of solid color in the print output. Hence, limits of −5 V and +5 V are set. These are shown as lines 340 (+5 V) and 350 (−5 V) in FIG. 3B. As is seen in FIG. 3B, certain derivative values exceed these limits (e.g. samples between increments 0 and 5, increments 11 and 12, and at increment 30).

FIG. 3B also shows a processed derivative signal 360. This processed signal 360 results from the application of the increments of FIG. 1B. As can be seen, the magnitudes of the derivative values are reduced so as to not exceed the limits, e.g. are reduced to a maximum value of 5 Volts. The total energy of the derivative signal is preserved by reassigning the differences in magnitude from the clipped signal samples to other surrounding signal samples. For example, for each reduction of 1 Volt to a derivative sample with a magnitude exceeding 5 Volts, another derivative sample within a predefined number of samples is increased by 1 Volt. This means that the sum of derivatives values is conserved. This also results in the conservation of the sum of the squares of the original signal 310 (i.e. conservation of the energy of the discrete signal). Line 320 of FIG. 3A shows the processed derivative signal following integration. This is performed to reconstitute a processed version of the original developer voltage control signal. The reconstituted developer voltage control signal may then be used as S′ to control the developer unit.

To see the effect of the presently described methods, a comparison may be made with a naively clipped signal. FIG. 3C shows the printer control signal 310 of FIG. 3A and a reconstituted signal following naïve clipping of derivative signal values to between −5 V and +5 V. For example, a comparative processed derivative signal is adjusted by setting any derivative value that exceeds the limits to the limit values. However, in this comparative case, signal energy is not distributed to neighboring samples. In this case, the clipping of derivative signal values without energy redistribution results in a processed printer control signal 380 that is offset from the original printer control signal 310. By comparing processed printer control signal 380 and processed printer control signal 320, it may be seen that the described methods generate a processed printer control signal 320 that is modified where limits are exceeded but that returns to original values where limits are not exceeded. For example, the processed printer control signal 320 coincides with the original printer control signal 310 between increments 15 and 25 where no limiting of the derivative is performed. Processed printer control signal 320 may be used to control developer unit voltages so as to provide uniform adjustment of solid color. For cases of mechanical control with different printer signals, the return to original sample values enables instructed positions to be reached.

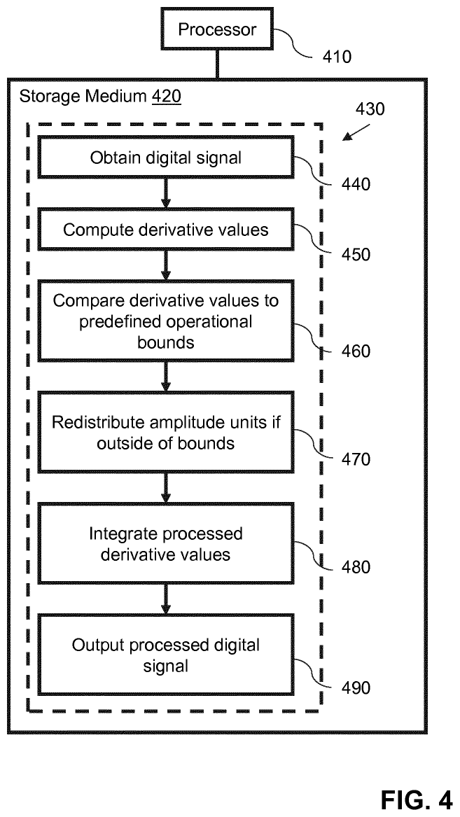

FIG. 4 shows a processor 410 and a non-transitory machine-readable storage medium 420 storing instructions 430. For example, the processor 410 may comprise a control processor or microprocessor for a LEP printing device. The instructions 430, when executed by the processor 410, cause the processor to perform the operations shown. At instruction 440, a digital signal to control a liquid electrophotographic printer is obtained. At instruction 450, derivative values for the obtained signal are computed. For example, this may comprise obtaining a signal similar to signal 310 in FIG. 3A and differentiating to obtain signal 330 in FIG. 3B. At instruction 460, the derivative values are compared to predefined operational bounds, e.g. limits 340 and 350 in FIG. 3B. At instruction 470, for derivative values that are outside of the predefined operational bounds, amplitude units of said values are redistributed to surrounding derivative values to conserve the sum of derivative values, e.g. to generate the values shown as line 360 in FIG. 3B. At instruction 480, the processed derivative values are integrated. This acts to generate a reconstituted signal such as signal 320 in FIG. 3A. At instruction 490, the processed, i.e. reconstituted, signal is used to control the LEP printing device during printing. For example, the processed signal may be used to control a change in voltage at a developer unit during printing. The predefined operational bounds may comprise a maximum and minimum allowed change in voltage value between samples. The digital signal obtained by instruction 440 may comprise a printer control signal resulting from processed image data, e.g. print data that is sent to the LEP printing device to print an image.

Certain examples described herein act to adjust printer control signals so as to limit the signals to avoid non-uniform changes while avoiding artifacts in print outputs. This allows, for example, solid uniformity of printed output to be corrected.

The preceding description has been presented to illustrate and describe examples of the principles described. This description is not intended to be exhaustive or to limit these principles to any precise form disclosed. Many modifications and variations are possible in light of the above teaching. It is to be understood that any feature described in relation to any one example may be used alone, or in combination with other features described, and may also be used in combination with any features of any other of the examples, or any combination of any other of the examples.

What is claimed is:

1. A method of operating a liquid electrophotographic printer comprising:
obtaining a set of limits for a printer control signal;
digitally processing the printer control signal to apply the obtained limits, including:
responsive to a value of the printer control signal exceeding one of the obtained limits,
reducing a magnitude of the value to within the obtained limits, and
modifying neighboring values to maintain the total energy of the printer control signal; and
controlling the liquid electrophotographic printer using the processed printer control signal.

2. The method of claim 1, wherein digitally processing the printer control signal comprises:
obtaining a derivative of the printer control signal; and
comparing values of the derivative of the printer control signal with the obtained limits.

3. The method of claim 2, including, responsive to a value of the derivative of the printer control signal exceeding one of the obtained limits:
reducing the magnitude of the value of the derivative of the printer control signal; and
increasing the magnitude of neighboring values of the derivative of the printer control signal.

4. The method of claim 3, comprising, prior to controlling the liquid electrophotographic printer:
integrating the modified values of the derivative of the printer control signal to generate the processed printer control signal.

5. The method of claim 1, wherein the neighboring values are identified using an energy spread function that identifies surrounding signal samples to receive redistributed units of value from a signal sample with a value exceeding one of the obtained limits.

6. The method of claim 1, wherein the printer control signal comprises a developer voltage signal and controlling the liquid electrophotographic printer comprises controlling a voltage of a developer unit of the liquid electrophotographic printer using the processed developer voltage signal.

7. A liquid electrophotographic printer comprising:
a binary ink developer unit; and
a voltage controller to:
receive a signal for the binary ink developer unit;
clip the signal within predefined bounds;
process the signal to maintain the energy of the originally received signal; and
supply the processed signal to the binary ink developer unit for use in setting voltage values of the binary ink developer unit during a print operation.

8. The liquid electrophotographic printer of claim 7, wherein the binary ink developer unit comprises:
a developer cylinder;
an electrode; and
an ink channel for supply of liquid toner to the developer cylinder,
wherein the processed signal is used to set the voltage of the developer cylinder during transfer of liquid toner from the developer cylinder to a photo imaging plate.

9. The liquid electrophotographic printer of claim 7, wherein the signal comprises values indicating changes in voltage to apply at the binary ink developer unit.

10. The liquid electrophotographic printer of claim 7, wherein the voltage controller is configured to clip a computed derivative of the signal.

11. The liquid electrophotographic printer of claim 10, wherein the voltage controller is configured to modify values of the computed derivative to redistribute units of value outside of the predefined bounds.

12. A non-transitory machine-readable storage medium storing instructions that, when executed by a processor, cause the processor to:
obtain a digital signal to control a liquid electrophotographic printer;
compute derivative values for samples of the digital signal;
compare the derivative values to predefined operational bounds;
for derivative values that are outside of the predefined operational bounds, redistribute amplitude units of the values to surrounding derivative values to conserve the sum of derivative values;
integrate the processed derivative values to generate a processed digital signal; and
output the processed digital signal for control of the liquid electrophotographic printer during printing.

13. The medium of claim 12, wherein the digital signal comprises samples representing changes in voltage to apply at a developer unit during printing.

14. The medium of claim 13, wherein the predefined operational bounds comprise a maximum and minimum allowed change in voltage value between samples.

15. The medium of claim 12, wherein the instructions are applied to digital signals generated based on image data for an image to be printed.
